(19) United States
(12) Patent Application Publication
(10) Pub. No.: US 2006/0068166 A1
(43) Pub. Date: Mar. 30, 2006

(54) Coating method, coating apparatus and coated medium

(75) Inventor: Shinsuke Takahashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/238,053

(22) Filed: Sep. 29, 2005

(30) Foreign Application Priority Data
Sep. 29, 2004 (JP) P.2004-284381

(51) Int. Cl. B05D 3/12; B05C 1/00; G11B 5/64; B32B 23/02

(52) U.S. Cl. 428/141; 427/355; 118/258; 118/244; 428/192

(57) ABSTRACT

A coating method for coating a coating liquid on a base by supplying the coating liquid between a rotating bar and the base, wherein the coating is executed while a film, having a thickness equal to or less than twice the coating thickness of the coating liquid to be coated on the base, is positioned between the bar and the base so as to cover the bar, thereby forming an uncoated area.

This application is based on Japanese Patent application JP 2004-284381, filed Sep. 29, 2004, the entire content of which is hereby incorporated by reference. This claim for priority benefit is being filed concurrently with the filing of this application.

### BACKGROUND OF THE INVENTION

1. Technical Field of the Invention

The present invention relates to a coating method for coating a coating liquid on a transported coating medium to be coated by supplying the coating liquid between a rotating bar and the coating medium.

2. Description of the Related Art

For enabling a recording of a digital high-television broadcasting, investigations are being made for an optical information recording medium which enables a recording of a higher density than in the high-density optical information recording medium (DVD), and an optical disk system utilizing a blue-purple laser and a high NA (numerical aperture) pickup is being developed.

For such optical disk system, a standard for a next-generation optical disk, called blue-ray disk, is already known. Such blue-ray disk is an optical information recording medium having a recording layer on a substrate, and a transparent layer on a laser entrance side of the recording layer. The transparent layer is formed, as described in JP-A-2000-67468, by coating a scratch resistant hard coat layer on a light transmitting layer constituted of polycarbonate.

An apparatus for producing the transparent layer is constituted, for example, of a base roll formed by winding a polycarbonate base, employed as a base film of the transparent layer, on a core; a driving roller for unwinding and transporting the base from the base roll; a coating part for coating an ultraviolet curable composition for forming the hard coat layer by a coating member on the base transported by the driving roller; a drying part for drying the ultraviolet curable composition coated by the coating part; an ultraviolet irradiating part for curing the ultraviolet curable composition, dried by the drying part, with an ultraviolet irradiation; and a winding part for winding the base, having passed the ultraviolet irradiating part, on a core.

Such coating part principally employs a bar coating method of coating a coating liquid on a base by supplying the coating liquid between a rotating bar and the continuously running base. The bar coating method is a simple and reliable coating method, but tends to form a thick coating on both edge portions of the base and is difficult to form uncoated areas on both edge portions (generally called ears) in stable manner, and various proposals have been made for improving such situations.

For example it is proposed to form an uncoated area 21 as shown in FIG. 4, by employing a wired bar 20 which is not wound with a wire in a part where an uncoated area is to be formed, as the rotating bar. However, such method results in a local thicker coating in a boundary of a wired part and a non-wired part and is difficult to maintain a dimensional precision of the wire.

It is also proposed, as shown in FIGS. 5A and 5B, to press a blade 23 to a rotating bar 22 at an upstream side thereof to scrape off a coating liquid 22a brought up by the bar 22, thereby forming an uncoated area (cf. JP-A-60-225669 and JP-A-8-84953). FIG. 5B is a view seen from the lateral side of the mechanism shown in FIG. 5A. This method requires a complex alignment of the bar and the blade, and the blade has to be pressed with a strong pressure for efficiently scraping off the coating liquid, thereby causing a damage on the bar.

It is also proposed, as shown in FIG. 6, to pre-coat an area 26 where an uncoated area is to be formed, with a liquid 25 similar to a solvent, thereby preventing the coating liquid from spreading to the area 26 and thus forming the uncoated area (cf. JP-A-7-155680). This method is advantageous in restricting a coating width without a mechanical contact with the bar, but requires another coating part for pre-coating the liquid 25 whereby the apparatus becomes complicated. Also the coating liquid may be contaminated with the liquid 25.

Therefore, there is known a method, for forming an uncoated area in a simple manner without requiring a complex structure, of executing the coating by placing a wiper material of an arbitrary dimension between the rotating bar and the base material (JP-A-60-225669). Such method, only requiring to place the wiper material between the rotating bar and the base material, can form an uncoated area without a complex structure.

Any of the aforementioned methods is incapable of sufficiently preventing a thicker coating in a boundary portion between an uncoated area and a coated area, and an improvement on this point is necessary.

### SUMMARY OF THE INVENTION

The present invention has been made in consideration of the foregoing situation, and an object of the invention is to provide a coating method capable of forming an uncoated area in a simple manner and also sufficiently preventing a thicker coating in the boundary portion between an uncoated area and a coated area, and to provide a coating apparatus. The object is achieved by the following invention.

(1). A coating method for coating a coating liquid on a transported coating medium to be coated by supplying the coating liquid between a rotating bar and the coating medium,
wherein the method comprises executing the coating while a film, having a thickness equal to or less than twice the coating thickness of the coating liquid to be coated on the coating medium, is positioned between the bar and the coating medium so as to cover the bar, thereby forming an uncoated area, and
wherein the coating liquid has a viscosity of 8 cp or less and a surface tension of 30 dyne/cm or less.

(2). The coating method according to (1), wherein a width of the uncoated area is set at 5 mm or more.

(3). The coating method according to (1), wherein a width of the uncoated area is set at 15 mm or more.

(4). The coating method according to any one of (1) to (3), wherein the film is made of PET.

(5). A coating apparatus for coating a coating liquid on a transported coating medium to be coated by supplying the coating liquid, the coating apparatus comprising:
a pass roller that guides the transported coating medium;
a coating member provided with a rotating bar that is brought in contact with the transported coating medium and serves as a coating nozzle when coating the coating liquid; and
a film that hangs over a part of the rotating bar to form an uncoated are
wherein the film has a thickness equal to or less than twice the coating thickness of the coating liquid to be coated on the coating medium, and
wherein the coating liquid has a viscosity of 8 cp or less and a surface tension of 30 dyne/cm or less.

(6). The coating apparatus according to (5), wherein a width of the uncoated area is set at 5 mm or more.

(7). The coating apparatus according to (5), wherein a width of the uncoated area is set at 15 mm or more.

(8). The coating apparatus according to any one of (5) to (7), wherein the film is made of PET.

(9). The coating apparatus according to any one of (5) to (8), wherein the coating member is capable of moving the position thereof.

(10). The coating apparatus according to any one of (5) to (9), wherein the rotating bar is a flat bar.

(11). The coating apparatus according to any one of (5) to (9), wherein the rotating bar is a wiring bar.

(12). A coated medium coated with the coating liquid according to the coating method according to any one of (1), wherein, at a boundary between a coated area and an uncoated area on the coating medium, the coated area has a coating thickness within a range from +0.0 to +2.0 μm with respect to an average coating thickness in a transversal direction of the coated area.

(13). The coated medium according to (12), wherein a width of the uncoated area is set at 5 mm or more.

(14). The coated medium according to (12), wherein a width of the uncoated area is set at 15 mm or more.

(15). The coated medium according to any one of (12) to (14), wherein the film is made of PET.

The present invention allows to form the ears in a simple method and to reduce a heaping of the coating liquid at the boundary portion between the uncoated area and the coated area. Further, the coating liquid can exude in a contact face of the film with the coated medium in such an amount as not to constitute a coated area, thereby providing a lubricancy and the sliding motion of the coating medium is facilitated. It is therefore rendered possible to avoid a damaging on the coating medium or a peeling-off of the film.

The present invention can also provide a coating appartus capable of forming an uncoated area in a simple manner and also sufficiently preventing a thicker coating in the boundary portion between an uncoated area and a coated area.

### BRIEF DESCRIPTION OF THE DRAWINGS

FIG. 1 is a schematic view showing a configuration of a producing system for producing a transparent layer for an optical information recording medium according to an embodiment of the invention.

FIG. 2 is a view showing a configuration of the coating apparatus in the producing system shown in FIG. 1.

FIG. 3A is a perspective view of the coating apparatus, and FIG. 3B is a view of the apparatus shown in FIG. 3A seen from an axial direction of the coating rod.

FIG. 4 is a view showing a related art method proposed for forming an uncoated area.

FIGS. 5A and 5B are views showing a related art method proposed for forming an uncoated area.

FIG. 6 is a view showing a related art method proposed for forming an uncoated area.

### DETAILED DESCRIPTION OF THE INVENTION

The present embodiment explains the coating method of the present invention, in an example of a producing system for a transparent layer for an optical information recording medium.

The optical information recording medium means an information recording medium capable of reproducing an information signal by optical means. The optical information recording medium is basically constituted of a substrate, a recording layer, and a transparent layer. In the optical information recording medium, each of such components has to be provided at least in one unit, but may be present in plural layers, and a layer may be formed from plural layers different in composition or characteristics. Also the optical information recording medium may be provided, in addition to the aforementioned layers, with an antistatic layer, a lubricating layer, a protective layer, a reflective layer and the like. Also a label may be printed on a surface of the substrate opposite to the recording layer.

The optical information recording medium for example has a disk shape, which is not restricted in diameter and the like. The optical information recording medium may also have a configuration to be contained and supported in a cartridge.

The transparent layer has a function of guiding a light irradiating for reproducing a record, to the recording layer and also a function of chemically and mechanically protecting the recording layer. The transparent layer is constituted of a base film (translucent film) and a hard coat layer for antiscratching on the surface thereof, and may suitably contain an adhesive layer and an antistain layer. The base film can be formed for example of polycarbonate, triacetyl cellulose (TAC), polyethylene terephthalate (PET), polyethylene naphthalate (PEN), polyimide or polyamide.

The hard coat layer can be formed by coating and drying a ultraviolet curable composition which is cured by an irradiation with actinic light, preferably ultraviolet light, on the base film and curing such composition with an ultraviolet irradiation. The ultraviolet curable composition preferably employs a compound having two or more ethylenic unsaturated groups within a molecule and being cured by a polymerization or a crosslinking by an ultraviolet irradiation.

The hard coat layer preferably has a pencil hardness of B or higher, more preferably H or higher. The pencil hardness is determined as a hardness of a pencil not causing a scratch under a load of 9.8 N, according to a pencil hardness testing method defined in JIS-K-5400, utilizing a pencil defined in JIS-S-6006.

In the following, an embodiment of a producing system for a producing method of the invention will be explained in detail with reference to the accompanying drawings.

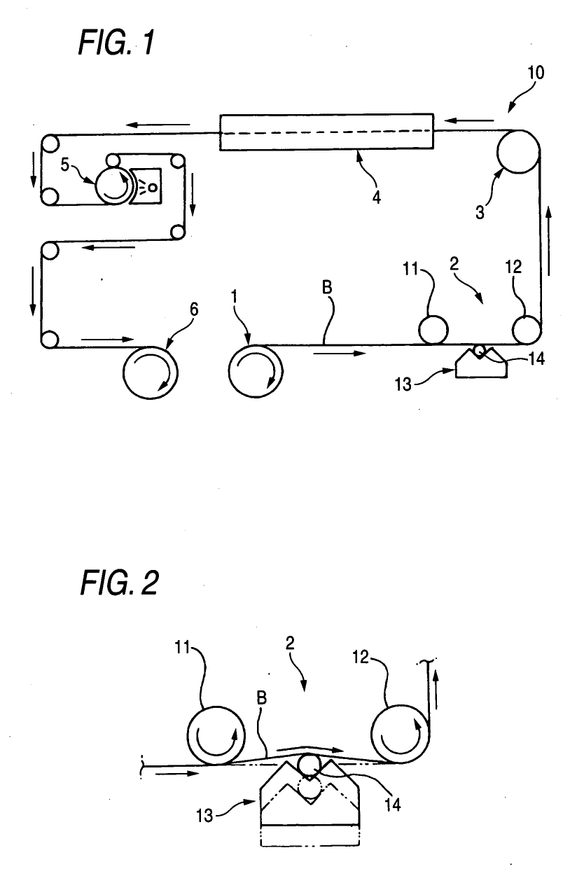

FIG. 1 shows a schematic configuration of a producing system for producing a transparent layer of an optical information recording medium of the invention.

As shown in FIG. 1, a producing system 10 for the transparent layer transports a base B of polycarbonate between a base roll (bulk) 1 formed by winding the base B on a core and a winding roll 6 for winding and supporting the base B, by advancing from the base roll 1 to the winding roll 6. The base B corresponds to a coating medium of the invention.

The producing system 10 is provided, along the transporting direction of the base B, with a coating apparatus 2, a pull roller 3, a drying part 4 and an ultraviolet irradiating part 5, in this order. The winding roller 6 is the base wound on a core.

The coating apparatus 2 is for example a bar coater, which is provided with a coating member 13 connected to an unillustrated coating liquid supply part. The coating member 13 attaches the coating liquid supplied from the coating liquid supply part onto a coating rod (coating bar) 14 serving as a coating nozzle, rotates such coating rod 14 and presses the coating rod 14 to the surface of the continuously running base B, thereby coating the coating liquid. The coating rod 14 may be rotated in a forward direction or in a reverse direction, and may have a constant or variable rotating speed.

The coating member 13 is rendered arbitrarily movable between a position (wrapping portion) in which the coating rod 14 is pressed to the base B and a position in which the coating rod 14 is separated from the base B. In the producing system 10 of the present embodiment, the coating member 13 is moved in a coating state to the position where the coating rod 14 is pressed to the base B, and, other than the coating state, the coating rod 14 is separated from the base B.

In the present embodiment, the coating liquid can be a composition constituted of a solvent such as isopropyl alcohol (IPA), methyl ethyl ketone (MEK) or methyl isobutyl ketone (MIBK), Si particles, an ultraviolet curable resin, and a polymerization initiator.

The pull roller 3 is rotated at the coating operation, is contacted at the periphery thereof with the base B for transporting the base B, and constitutes a reference for the transporting speed of the base B. The pull roller 3 is controlled by an unillustrated pull roller controller and transports the base B at a constant speed. The pull roller 3 may be provided with grooves on the surface thereof in order to secure a supporting force to the base B, or may hold the base B by air suction.

The drying part 4 dries the coating liquid coated on the base B while it is transported.

The ultraviolet irradiating part 5 irradiates a surface of the base B coated with the coating liquid, with an ultraviolet light while the base B is transported, thereby curing the coating layer. The ultraviolet irradiating part 5 may emit actinic light other than the ultraviolet light as long as the coating liquid can be cured. The transparent layer is completed by the curing of the coating layer.

In the following, the configuration of the coating apparatus 2 will be explained. FIG. 2 illustrates a configuration of the coating apparatus of the present embodiment.

As illustrated in FIG. 2, a pass roller 11 is provided at an upstream side of the coating member 13, in the transporting direction of the base B, and a pass roller 12 is provided at a downstream side of the coating member 13.

The pass rollers 11, 12 are rotated by the transported base B at the coating operation. In the present embodiment, the pass rollers 11, 12 are idler rollers not connected to a driving shaft or a driving motor.

At the coating operation, even when a transport path length of the base B changes by a contact of the coating member 13 with the transported base B, since the pass rollers supporting the transported base B are idler rollers, they freely rotate so as to follow the speed of the base B. Therefore, there is not generated a stick slip by a change in the contact pressure of the base B with the pass rollers 11, 12 and it is possible to prevent a buckling in a contact portion of the base B with the pass rollers 11, 12.

In the following, there will be explained, in the coating operation executed by the coating apparatus 2, a method for forming an uncoated area.

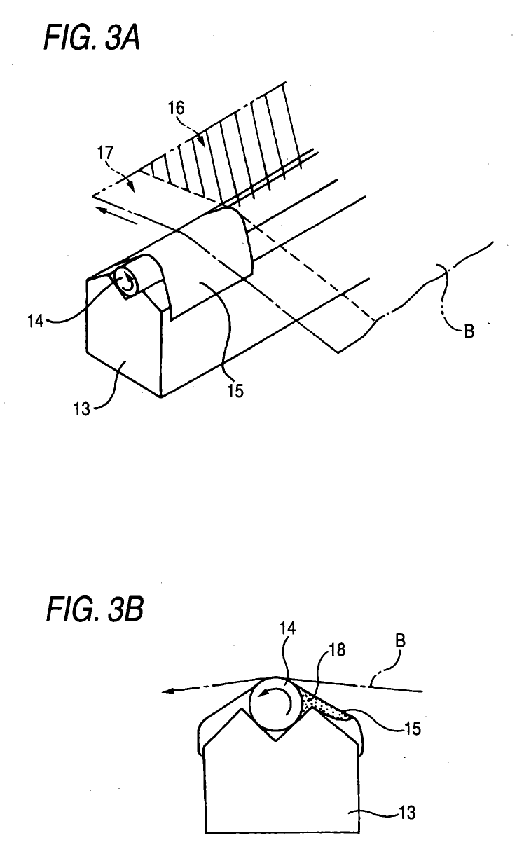

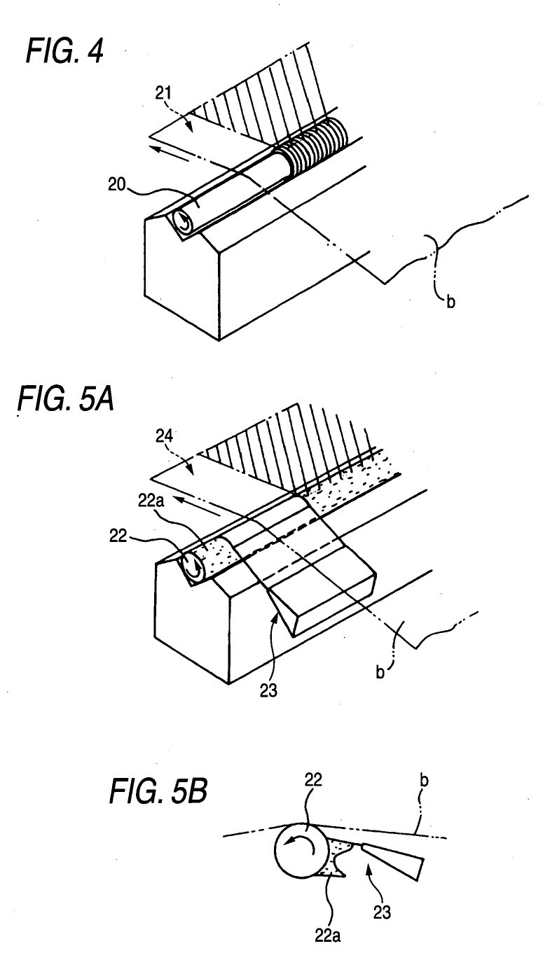

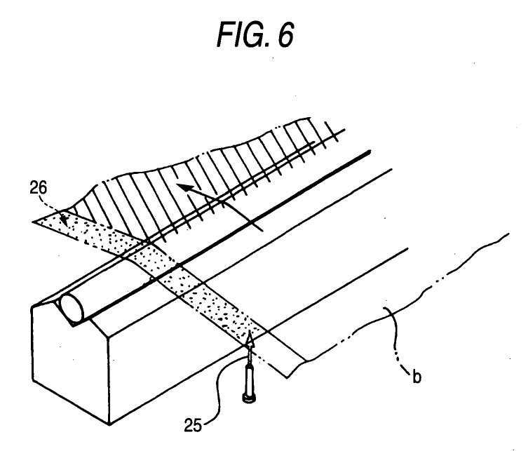

FIG. 3A is a perspective view of the coating apparatus, and FIG. 3B is a view of the apparatus shown in FIG. 3A, seen from an axial direction of the coating rod.

As shown in FIGS. 3A and 3B, the coating apparatus 2 is provided with a film 15 of an arbitrary size, provided on a part of the coating rod 14 so as to cover the same. The film 15 has a thickness preferably equal to or less than twice the thickness of the coating liquid coated on the base B. The film 15 is required to have a width equal to or larger than an uncoated area 17 to be formed on the base B (area outside a dotted line on the base B shown in FIG. 3A in the transversal direction of the base B (perpendicular to the transporting direction thereof)), and a length capable of covering the coating rod 14. The film 15 may be provided, when seen in a direction from above in FIG. 3B, in such a position that the uncoated area to be formed on the base B is superposed on the coating rod 14. As shown in FIG. 3B, the film 15 is adhered at both ends thereof to the coating member 13, for example with an adhesive material. The film 15 is formed for example with PET. A width of the uncoated area 17 is preferably 5 mm or larger, more preferably 15 mm or larger.

At the coating process, the coating rod 14 is rotated in the forward or reverse direction, and the coating liquid is supplied between the coating rod 14 and the base B, whereby, within the surface opposed to the coating rod 14 of the base B transported in a direction indicated by an arrow in FIGS. 3A and 3B, the coating liquid is coated with a predetermined thickness in a contact area 16 with the coating rod 14 (coated area). On the other hand, in a contact area 17 with the film 15 (uncoated area) within the surface opposed to the coating rod 14 of the base B transported in a direction indicated by an arrow in FIGS. 3A and 3B, the coating liquid 18 is intercepted by the film 15 and is scarcely coated on the base B (cf. FIG. 3B). Thus, by merely positioning the film 15 between the base B and coating rod 14 at the coating operation, it is rendered possible to realize an almost zero coating amount of the coating liquid in a portion where the film 15 is provided, thereby forming the uncoated area 17 in a simple manner.

It is a finding of the present inventors that a coating thickness of the coated area 16 (thickness of coated layer) after drying at a boundary between the coated area 16 and the uncoated area 17 can be made sufficiently small by selecting a thickness of the film 15 equal to or less than twice the thickness of the coating liquid to be coated on the base B. In this manner, the coating thickness of the coated area 16 after drying at the boundary of the coated area 16 and the uncoated area 17 can be brought to a range of +0.0 to +2.0 μm with respect to an average coating thickness in the transversal direction of the coated area 16.

It is also a finding of the present inventors that a coating liquid having a viscosity of 8 cp or less and a surface tension of 30 dyne/cm or less can exude on a surface of the film 15 in contact with the base B, in a small amount (an amount sufficiently thinner than the thickness of the coating liquid in the coated area), thereby increasing the lubricancy and sufficiently facilitating sliding of the base B on the film 15. Such facilitated sliding of the base B on the film 15 allows to prevent a damage on the base B or a ripping-off of the film 15 from the coating member 13. It is more preferable that a coating liquid having a viscosity of 4 cp to 8 cp and a surface tension of 25 to 28 dyne/cm.

In the following, the effect of the invention will be clarified by an example.

### EXAMPLE

In the present example, a transparent layer was produced by a producing system shown in FIG. 1.

Following experimental conditions were adopted:
base B: material: PET, width: 550 nm, thickness: 90 μm,
coating liquid x: formed from 300 parts by weight of acrylate resin, 400 parts by weight of IPA and 600 parts by weight of MIBK, liquid viscosity: 4, 8 or 12 cp, surface tension: 25 or 28 dyne/cm,
coating liquid y: aqueous coating liquid, liquid viscosity: 4 cp, surface tension 55 dyne/cm,
coating apparatus 2 (bar coater): face width: 600 mm, liquid emitting width 500 mm, coating speed: 15 m/min, bar diameter: 8φ, liquid emitting rate: 4 liter/min,
film 15: material: PET, thickness: 6, 10, 20 or 90 μm.

A coating amount of the coating liquid in the coated area 16 was selected as 9 or 15 cc/m². The viscosity of the coating liquid x was regulated by varying a solid concentration thereof and suitably adding a viscosity regulating agent.

The coating liquid was coated on the base B under the aforementioned conditions and with the film 15 pinched between the base B and the coating rod 14 as shown in FIGS. 3A and 3B, then dried, and a thickness of the coated base B was measured in the transversal direction with a continuous film thickness meter. A difference between the coating thickness in the coated area 16 at the boundary with the uncoated area 17 and the coating thickness of the coated area 16 averaged in the transversal direction was determined as a heaping at such boundary. Also a product of a poor quality was rated as “−” and a product of a satisfactory quality was rated as “+”. Results are shown in Table 1.

TABLE 1

| | Coating | Film | Liquid | Surface | | | |
|---|---|---|---|---|---|---|---|
| | thickness | thickness | viscosity | tension | Heaping | Others | Evaluation |
| Example 1 | 9 cc/cm² | 6 μm | 4 cp | 25 dyne/cm | 0.0 μm | | + |
| Example 2 | 9 cc/cm² | 10 μm | 4 cp | 25 dyne/cm | 0.0 μm | | + |
| Comp. Ex. 1 | 9 cc/cm² | 20 μm | 4 cp | 25 dyne/cm | 1.5 μm | | − |
| Comp. Ex. 2 | 9 cc/cm² | 90 μm | 4 cp | 25 dyne/cm | 5.2 μm | | − |
| Example 3 | 15 cc/cm² | 20 μm | 4 cp | 25 dyne/cm | 0.1 μm | | + |
| Comp. Ex. 3 | 15 cc/cm² | 90 μm | 4 cp | 25 dyne/cm | 5.0 μm | | − |
| Example 4 | 9 cc/cm² | 10 μm | 8 cp | 28 dyne/cm | 0.3 μm | | + |
| Comp. Ex. 4 | 9 cc/cm² | 10 μm | 12 cp | 28 dyne/cm | 0.3 μm | base scraped | − |
| Comp. Ex. 5 | 9 cc/cm² | 10 μm | 4 cp | 55 dyne/cm | 2.4 μm | aqueous coating | − |
| | | | | | | solution is used., | |
| | | | | | | base scraped | |

Comparison of Examples 1, 2 and Comparative Examples 1, 2 and of Examples 3 and Comparative Example 3 proved that the heaping could be sufficiently suppressed by selecting the thickness of the film 15 to be equal to or less than twice the coating thickness of the coating liquid. Also as will be apparent from a comparison of Examples 4 and Comparative Examples 4, 5 it was proven that the coating liquid satisfying the conditions of the invention could maintain a satisfactory quality without causing a damage on the base B or a peeling-off of the film 15.

The present invention is not limited to the aforementioned embodiment but is subject to modifications or improvements. For example, the coating apparatus 2 of the example employed a flat bar (plain bar) without a winding wire as the bar 14, but similar effects can be obtained also with a wire-wound bar.

What is claimed is:

1. A coating method for coating a coating liquid on a transported coating medium to be coated by supplying the coating liquid between a rotating bar and the coating medium,
wherein the method comprises executing the coating while a film, having a thickness equal to or less than twice the coating thickness of the coating liquid to be coated on the coating medium, is positioned between the bar and the coating medium so as to cover the bar, thereby forming an uncoated area, and
wherein the coating liquid has a viscosity of 8 cp or less and a surface tension of 30 dyne/cm or less.

2. The coating method according to claim 1, wherein a width of the uncoated area is set at 5 mm or more.

3. The coating method according to claim 1, wherein a width of the uncoated area is set at 15 mm or more.

4. The coating method according to claim 1, wherein the film is made of PET.

5. A coating apparatus for coating a coating liquid on a transported coating medium to be coated by supplying the coating liquid, the coating apparatus comprising:
a pass roller that guides the transported coating medium;
a coating member provided with a rotating bar that is brought in contact with the transported coating medium and serves as a coating nozzle when coating the coating liquid; and
a film that hangs over a part of the rotating bar to form an uncoated are
wherein the film has a thickness equal to or less than twice the coating thickness of the coating liquid to be coated on the coating medium, and
wherein the coating liquid has a viscosity of 8 cp or less and a surface tension of 30 dyne/cm or less.

6. The coating apparatus according to claim 5, wherein a width of the uncoated area is set at 5 mm or more.

7. The coating apparatus according to claim 5, wherein a width of the uncoated area is set at 15 mm or more.

8. The coating apparatus according to claim 5, wherein the film is made of PET.

9. The coating apparatus according to claim 5, wherein the coating member is capable of moving the position thereof.

10. The coating apparatus according to claim 5, wherein the rotating bar is a flat bar.

11. The coating apparatus according to claim 5, wherein the rotating bar is a wiring bar.

12. A coated medium coated with the coating liquid according to the coating method according to claim 1, wherein, at a boundary between a coated area and an uncoated area on the coating medium, the coated area has a coating thickness within a range from +0.0 to +2.0 μm with respect to an average coating thickness in a transversal direction of the coated area.

13. The coated medium according to claim 12, wherein a width of the uncoated area is set at 5 mm or more.

14. The coated medium according to claim 12, wherein a width of the uncoated area is set at 15 mm or more.

15. The coated medium according to claim 12, wherein the film is made of PET.
